(19) United States
(12) Patent Application Publication
(10) Pub. No.: US 2017/0282264 A1
(43) Pub. Date: Oct. 5, 2017

(54) Hand-Held Cutting Tool

(71) Applicants: Robert Bosch GmbH, Stuttgart (DE); Robert Bosch Engineering and Business Solutions Private Limited, Bangalore (IN)

(72) Inventors: Gopinath Alagesan, Coimbatore (IN); Jagadish Gona, Madurai (IN); Prasanna Govindan, Bangalore (IN); Raja Iruthayaraj, Coimbatore (IN)

(21) Appl. No.: 15/470,026

(22) Filed: Mar. 27, 2017

(30) Foreign Application Priority Data
Mar. 30, 2016 (IN) 201641011106

(51) Int. Cl. B23D 51/16; F16F 15/20; F16F 15/12; B25D 11/06

(52) U.S. Cl. CPC B23D 51/16; B25D 11/062; F16F 15/20; F16F 15/1201; F16F 2236/045

(57) ABSTRACT

A hand-held cutting tool includes a handle, an operating unit, and a dampening arrangement. The handle includes a stationary part and a flexible part pivotally attached to the stationary part. At least a portion of the operating unit is fitted to the flexible part and at least one part of the dampening arrangement is located in stationary part. The dampening arrangement includes a rod that connects the flexible part to the stationary part of the handle. The rod is connected to the stationary part by a flexible element configured to dampen vibrations of the operating unit relative to the handle. The rod is connected to the flexible part by a pivot pin configured to dampen the vibrations of the operating unit relative to the handle.

### FIELD OF THE INVENTION

The invention here relates to a hand held cutting tool.

### BACKGROUND OF THE INVENTION

Hand held power tools are generally motor driven, such as saber saws and larger reciprocating saws are usually driven by electric motors that have a rotating output shaft. The rotating motion is translated into reciprocating motion of a working shaft for moving a saw blade or the cutting unit in a reciprocating manner. Various approaches have been developed which translate the rotational motion into reciprocating motion. A common approach is the incorporation of a wobble shaft. A wobble shaft assembly is a configuration wherein a shaft has an angled portion on which an arm is mounted through a ball bearing assembly. The arm is slidably positioned within a portion of a plunger assembly. As the angled portion of the shaft rotates, the arm translates the rotation of the shaft into a reciprocating movement of the plunger assembly.

The patent application 0820080052923 explains the drive mechanism for a reciprocating saw. Embodiments of a reciprocating drive apparatus are disclosed which comprises a housing, a drive shaft rotatably mounted in the housing, an elongated plunger mounted in the housing for reciprocating motion, the plunger having a rear end portion configured to engage a wobble plate interface structure and a front end portion for attaching a tool, a first bushing positioned in the housing for retaining the front end portion in a manner whereby the plunger is not restrained from rotating about a first axis of rotation, a second bushing positioned in the housing for receiving the rear end portion of the elongated plunger in a manner whereby the plunger is not restrained from rotating along a second axis of rotation as the plunger reciprocates in the bushing, a wobble shaft assembly operatively connected to the drive shaft and having an elongated arm with a wobble plate interface structure for engaging the rear end portion of the plunger and reciprocating the plunger in the first and second bushings.

### BRIEF DESCRIPTION OF THE ACCOMPANYING DRAWINGS

An exemplifying embodiment of this disclosure is explained in principle below with reference to the drawings. The drawings are,

FIG. 1 illustrates a view of a hand held cutting tool 100 according to an embodiment of this disclosure; and

FIG. 2 illustrates a view of dampening arrangement 200 according to an embodiment of this disclosure.

### DETAILED DESCRIPTION OF THE INVENTION

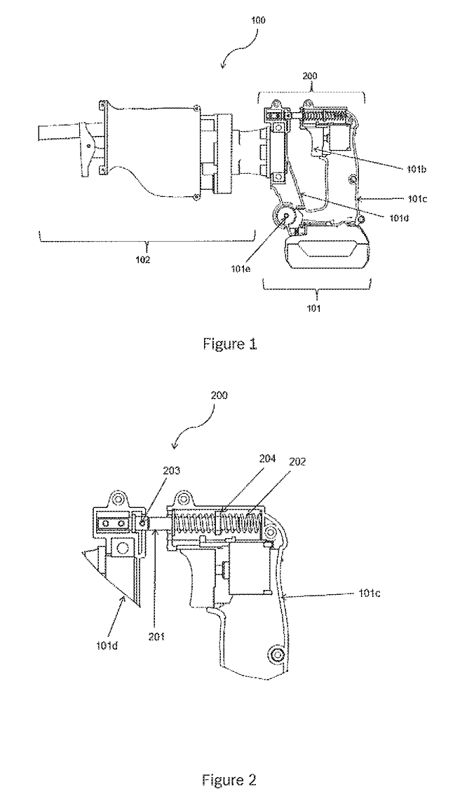

FIG. 1 illustrates the hand held cutting tool 100 according to an embodiment disclosure.

The hand-held cutting tool 100 comprises a handle 101, an operating unit 102 and a dampening arrangement 200. The handle 101 comprises a stationary part 101c and a flexible part 101d. The stationary part 101c is with a trigger 101b and is adapted to be held by user. The flexible part 101d is pivotally 101e attached to the stationary part 101c. At least a portion of the operating unit 102 is fitted to the flexible part 101d of the handle 101. The dampening arrangement 200 comprises a rod 201 connecting at least one part of the dampening arrangement 200 located in the stationary part 101c and at least one part of the dampening arrangement located in the flexible part 101d of the handle 101. The rod 201 is connected to stationary part 101c by a flexible element 202 and adapted to dampen the vibrations of the operating unit 102 relative to the handle 101. The rod 201 being connected to flexible part 101d by a pivot pin 203 and adapted to dampen the vibrations of the operating unit 102 relative to the handle 101.

According to an embodiment of this disclosure, the rod 201 is being connected to stationary part 101c of the handle 101 in the dampening arrangement 200 by at least two flexible elements 202 and a holding element 204. Here flexible element 202 is for example a spring so that the rod 201 is held in the spring in the stationary part 101c of the handle 101 and the rod 201 reciprocates during the operation of the operating unit 102.

According to an embodiment of the disclosure, the holding element 204 is, for example, a disc located in between at least two flexible elements 202 in the dampening arrangement 200. The purpose of the holding element 204 is to stop the reciprocation of rod 201 inside the stationary part 101c once the flexible element 202 i.e. the spring reaches the maximum compression.

For the purpose of better understanding of this disclosure, the hand held cutting tool 100 is a reciprocating tool, When the trigger 101b is pressed the operating unit 102 starts operating and starts the cutting process. During the cutting process, the cutting force is transmitted to the flexible part 101d of the handle 101 which is pivotally 101e connected to the stationary part 101c of the handle 101. Due to the cutting force, the operating unit 102 reciprocates backward towards the stationary part 101c and causes vibrations. These vibrations get dampens in the dampening arrangement 200 of the stationary part 101c of the handle 101. Since the stationary part 101e is held by the user therefore the user will not feel the vibrations in the hand and hence the use of the hand held cutting tool 100 as disclosed in the disclosure is free from vibrations for the user during the cutting operation.

In the dampening arrangement 200, the rod 201 is connected to the flexible part 101d by a pivot pin 203 so that the vibrations from the operating unit 102 will not reach to the stationary part 101c of the handle 101 and as connected to the pivot pin 203 the rod 201 reciprocates inside the flexible element 202 and then the holding element 204 stops the reciprocation of the rod 201. based on the complete compression of one of the flexible element 202 hence the stationary part 101c of the handle remains free from the vibrations.

The hand held cutting tool 100 as disclosed above in the disclosure can be used for long working hours by the user without any fatigue feeling as there is low or negligible vibration feel by the hand of the user and the dampening arrangement 200 dampens the vibrations caused by the operating unit 102. Also the hand arm vibration syndrome can be avoided by the use of this hand held cutting tool 100 and the tool can be used for long working hours without any break.

It must be understood that the embodiments explained in the above detailed description in only illustrative and does not limit the scope of this invention. The scope of this invention is limited only by the scope of the claims. Many modification and changes in the embodiments aforementioned are envisaged and are within the scope of this invention.

1. A hand-held cutting tool, comprising:
a handle including:
a stationary part with a trigger, the stationary part configured to be held by a user; and
a flexible part pivotally attached to the stationary part;
an operating unit having at least a portion fitted to the flexible part; and
a dampening arrangement having (i) at least one part located in the stationary part of the handle and (ii) at least one part located in the flexible part of the handle,
wherein the damping arrangement includes a rod connecting the at least one part of the dampening arrangement located in the stationary part and the at least one part of the dampening arrangement located in the flexible part,
wherein the rod is connected to the stationary part by a flexible element configured to dampen vibrations of the operating unit relative to the handle, and
wherein the rod is connected to the flexible part by a pivot pin configured to dampen the vibrations of the operating unit relative to the handle.

2. The hand-held cutting tool as claimed in claim 1, wherein the rod is connected to the stationary part of the handle in the dampening arrangement by at least two said flexible elements and a holding element.

3. The hand-held cutting tool as claimed in claim 2, wherein the holding element is located in between the at least two said flexible elements in the dampening arrangement.
